(19) United States
(12) Patent Application Publication
(10) Pub. No.: US 2019/0196476 A1
(43) Pub. Date: Jun. 27, 2019

(54) FLYING DEVICE, METHOD OF CONTROLLING FLYING DEVICE, AND STORAGE MEDIUM

(71) Applicant: CASIO COMPUTER CO., LTD., Tokyo (JP)

(72) Inventors: Hideaki MATSUDA, Tokyo (JP); Takahiro MIZUSHINA, Saitama (JP); Shunsuke YAMADA, Tokyo (JP); Toshihiro TAKAHASHI, Tokyo (JP); Masanori OHTA, Tokyo (JP); Shinji DAZAI, Tokyo (JP)

(73) Assignee: CASIO COMPUTER CO., LTD., Tokyo (JP)

(21) Appl. No.: 16/230,389

(22) Filed: Dec. 21, 2018

(30) Foreign Application Priority Data
Dec. 22, 2017 (JP) 2017-246112

(51) Int. Cl. G05D 1/02; B64C 39/02

(52) U.S. Cl. CPC G05D 1/0202; B64C 2201/141; B64C 2201/027; B64C 39/024

(57) ABSTRACT

In automatic travel control of a flying device towards a target, when a current distance from the target is large in comparison to a prescribed distance threshold, a controller of the flying device performs velocity feedback PID control to control the flight propulsion unit of the flying device. When the current distance becomes small in comparison to the prescribed distance threshold, the controller performs a hybrid of the velocity feedback PID control and position feedback PID control to control the flight propulsion unit such that as the flying device approaches the target, the position feedback PID control becomes more dominant than the velocity PID control. The processor calculates a weighted average of the respective manipulated variables with dynamically adjusted weights to achieve the hybrid control.

### BACKGROUND OF THE INVENTION

### Technical Field

The present invention relates to a flying device that flies autonomously, a method of controlling the flying device, and a storage medium.

### Background Art

Small unmanned flying devices that fly autonomously using a driving propulsion device constituted by rotor blades driven by a motor are generally referred to as so-called drones or multicopters (hereinafter, “drones”) and are a known technology (Patent Documents 1 and 2, for example).

One known form of motion control for when such flying devices fly autonomously is performing a type of feedback control known as proportional-integral-derivative control (PID control) on position. PID control is a method of feedback control which combines proportional action, integral action, and derivative action related to error corresponding to the difference between a control target value and a current process variable. As illustrated in FIG. 7A, for example, PID control of position involves using a current position 700 which is detected by a GPS sensor or the like in the flying device and a target position 701 which is the target destination to which the flying device should fly in order to determine a positional error 702 in an X-axis direction and a positional error 703 in a Y-axis direction within a mutually orthogonal two-dimensional XY coordinate axis system defined in a plane level to the ground, for example, calculating manipulated variables for each axial direction that will reduce those errors, and inputting these manipulated variables as instructions to the flight propulsion unit of the flying device. In FIG. 7A, the four circles illustrated at the current position 700 of the flying device represent propulsion units of the flying device and indicate that the propulsion units are being driven with the abovementioned manipulated variables for each axial direction being converted into two propulsion values for the two propulsion units represented by the darkened circles. Moreover, control for the height direction orthogonal to the ground is implemented separately but also by way of PID control.

Another known form of motion control is performing PID control on velocity. As illustrated in FIG. 7B, for example, PID control of velocity involves using the current position 700 and target position 701 of the same flying device as in FIG. 7A to first calculate a target velocity vector 704 for flying to the target position 701 within a plane parallel to the ground as in FIG. 7A. Then, the difference between this target velocity vector 704 and a current velocity vector 705 representing the current velocity within the plane as obtained by integrating the output of an acceleration sensor or the like in the flying device is calculated. More specifically, the current velocity vector 705 is decomposed into a horizontal decomposition component 706 of the current velocity vector 705 which is the component in the direction of an axis (hereinafter, a “horizontal axis”) going from the current position 700 towards the target position 701, as well as an orthogonal decomposition component 707 of the current velocity vector 705 which is the component in the direction of an axis (hereinafter, an “orthogonal axis”) that is orthogonal to the horizontal axis, for example. Next, a horizontal error 708 and an orthogonal error 709 are calculated as the differences between these components and components obtained by similarly decomposing the target velocity vector 704 in the horizontal and orthogonal directions. Then, manipulated variables for each axial direction that will reduce these errors are calculated, and those manipulated variables are input as instructions to the flight propulsion unit of the flying device. In FIG. 7B, similar to in FIG. 7A, the four circles illustrated at the current position 700 of the flying device represent propulsion units of the flying device and indicate that the propulsion units are being driven with the abovementioned manipulated variables for each axial direction being converted into two propulsion values for the two propulsion units represented by the darkened circles.

### RELATED ART DOCUMENTS

### Patent Documents

Patent Document 1: Japanese Patent No. 5432277

Patent Document 2: Japanese Patent Application Laid-Open Publication No. 2013-129301

### SUMMARY OF THE INVENTION

Accordingly, the present invention is directed to a scheme that substantially obviates one or more of the problems due to limitations and disadvantages of the related art.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a flying device, including: a propulsion unit; a sensor unit that detects at least a current position and a current velocity of the flying device; and a processor configured to receive a target position and calculate or receive a target velocity corresponding to the target position, the processor being further configured to perform: a velocity feedback control in which the current velocity is taken as a process variable and the target velocity is taken as a setpoint so as to generate a velocity-feedback manipulated variable for controlling the propulsion unit, and a position feedback control in which the current position is taken as a process variable and the target position is taken as a setpoint so as to generate a position-feedback manipulated variable for controlling the propulsion unit, wherein in at least a prescribed distance range of the flying device with respect to the target position, the processor calculates a weighted average of the velocity-feedback manipulated variable and the position-feedback manipulated variable and controls the proposition unit in accordance with the weighted averaged manipulated variable, thereby performing velocity-position hybrid feedback control, and wherein in the at least the prescribed distance range, the larger a current distance of the current position of the flying device from the target position is, the more weight the processor assigns to the velocity-feedback manipulated variable in the weighted average, and the smaller the current distance becomes, the more weight the processor assigns to the position-feedback manipulated variable in the weighted average, so that as the flying device approaches the target position, the position feedback control becomes more dominant relative to the velocity feedback control.

In the above-mentioned flying device, the prescribed distance range may be within a prescribed distance from the target position inclusive of the target position, and when the current position of the flying vehicle is beyond the distance range, the processor may perform only the velocity feedback control without performing the position feedback control in controlling the propulsion unit.

In the above-mentioned flying device, in the prescribed distance range, the weight the processor assigns to the velocity-feedback manipulated variable and the weight the processor assigns to the position-feedback manipulated variable in the weighted average may be both linear functions of the current distance of the current position of the flying device from the target position as detected by the detection unit.

In the above-mentioned flying device, in the prescribed distance range, the weight the processor assigns to the velocity-feedback manipulated variable may be a ratio of the current distance of the current position of the flying device from the target position as detected by the detection unit relative to an initial distance, the initial distance being either the prescribed distance or a distance of the flying device from the target position when the processor initially determines that the flying device is within the prescribed distance range and starts performing the velocity-position hybrid feedback control, a remaining weight being assigned to the position-feedback manipulated variable in the weighted average.

In the above-mentioned flying device, each of the velocity feedback control and the position feedback control may be proportional-integral-derivative (PID) feedback control.

In another aspect, the present disclosure provides a method to be performed by a processor in a flying device for controlling the flying device, the flying device further including a propulsion unit and a sensor unit that detects at least a current position and a current velocity of the flying device, the processor in the flying device being configured to: receive a target position and calculate or receive a target velocity corresponding to the target position: perform a velocity feedback control in which the current velocity is taken as a process variable and the target velocity is taken as a setpoint so as to generate a velocity-feedback manipulated variable for controlling the propulsion unit, and perform a position feedback control in which the current position is taken as a process variable and the target position is taken as a setpoint so as to generate a position-feedback manipulated variable for controlling the propulsion unit, the method including: in at least a prescribed distance range of the flying device with respect to the target position, causing the processor to calculate a weighted average of the velocity-feedback manipulated variable and the position-feedback manipulated variable; and controlling the proposition unit in accordance with the weighted averaged manipulated variable, thereby performing velocity-position hybrid feedback control, and wherein in the at least the prescribed distance range, the larger a current distance of the current position of the flying device from the target position is, the more weight the processor assigns to the velocity-feedback manipulated variable in the weighted average, and the smaller the current distance becomes, the more weight the processor assigns to the position-feedback manipulated variable in the weighted average, so that as the flying device approaches the target position, the position feedback control becomes more dominant relative to the velocity feedback control.

In another aspect, the present disclosure provides a non-transitory computer-readable storage medium having stored thereon a program executable by a processor in a flying device that further includes a propulsion unit and sensor unit that detects at least a current position and a current velocity of the flying device, the program configuring the processor to: receive a target position and calculate or receive a target velocity corresponding to the target position, perform a velocity feedback control in which the current velocity is taken as a process variable and the target velocity is taken as a setpoint so as to generate a velocity-feedback manipulated variable for controlling the propulsion unit, and perform a position feedback control in which the current position is taken as a process variable and the target position is taken as a setpoint so as to generate a position-feedback manipulated variable for controlling the propulsion unit, wherein in at least a prescribed distance range of the flying device with respect to the target position, the program causes the processor to calculate a weighted average of the velocity-feedback manipulated variable and the position-feedback manipulated variable and control the proposition unit in accordance with the weighted averaged manipulated variable, thereby performing velocity-position hybrid feedback control, and wherein in the at least the prescribed distance range, the larger a current distance of the current position of the flying device from the target position is, the more weight the processor assigns to the velocity-feedback manipulated variable in the weighted average, and the smaller the current distance becomes, the more weight the processor assigns to the position-feedback manipulated variable in the weighted average, so that as the flying device approaches the target position, the position feedback control becomes more dominant relative to the velocity feedback control.

An example of one aspect is a flying device including a propulsion unit, the flying device including: a sensor unit that detects at least a current position and a current velocity; and a controller that performs feedback control in which the larger a current distance between the current position detected by the sensor unit and a target position is, the more strongly velocity feedback control based on the current velocity detected by the sensor unit and on a target velocity corresponding to the target position is applied, and the smaller the current distance becomes, the more strongly position feedback control based on the current position detected by the sensor unit and on the target position is applied.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a cross-sectional view illustrating an example configuration of a flying device according to an embodiment.

FIG. 2A is a top view illustrating an example configuration of a portion within dashed box A of the flying device shown in FIG. 1.

FIG. 2B is a top view illustrating an example configuration of a portion within dashed box B of the flying device shown in FIG. 1.

FIG. 3 is a block diagram illustrating an example of a system of the flying device according to the embodiment.

FIG. 4 is a block diagram illustrating a PID control mechanism in the embodiment.

FIG. 5 is a flowchart illustrating an example of a motion control process for a controller.

FIG. 6 is an explanatory drawing of the operation of the embodiment.

FIG. 7A is an explanatory drawing of position-based PID control.

FIG. 7B is an explanatory drawing of velocity-based PID control.

### DETAILED DESCRIPTION OF EMBODIMENTS

An embodiment of the present invention will be described in detail below with reference to figures. In the present embodiment, in motion control of a flying device including a flight propulsion unit and a sensor unit that detects at least a current position and a current velocity, the flying device includes a controller that, with respect to a manipulated variable for the flight propulsion unit, performs feedback control in which the larger a current distance between the current position detected by the sensor unit and a target position is, the more strongly velocity PID control, for example, based on the current velocity detected by the sensor unit and on a target velocity corresponding to the target position is applied, and the smaller the current distance becomes, the more strongly position PID control, for example, based on the current position and on the target position is applied. Here, the controller inputs as an instruction to the flight propulsion unit a manipulated variable obtained by adding together manipulated variables obtained by respectively performing weighting on the velocity PID control and the position PID control in accordance with the current distance. More specifically, when the current distance is large in comparison to a prescribed distance threshold, the controller inputs as an instruction to the flight propulsion unit a manipulated variable output by the velocity PID control. Moreover, when the current distance becomes small in comparison to the prescribed distance threshold, the controller inputs as an instruction to the flight propulsion unit a manipulated variable obtained by setting a distance between the current position at a current moment and the target position as a remaining travel distance, performing weighting of a magnitude proportional to a ratio of the current distance to the remaining travel distance on the output of the velocity PID control, performing weighting of a magnitude inversely proportional to the above-mentioned ratio on the output of the position PID control, and adding together a manipulated variable obtained by weighting the output of the velocity PID control and a manipulated variable obtained by weighting the output of the position PID control. Due to this type of control, the present embodiment makes it possible to, when the current position of the flying device is far away from the target position, perform control that applies the velocity PID control-only feedback control and thereby keeps the speed of the flying device as constant as possible, and, when the flying device gets close to the target position, perform control that applies feedback control which gradually transitions from velocity PID control to position PID control and thereby makes the flying device smoothly arrive and stop (hover) at the target position.

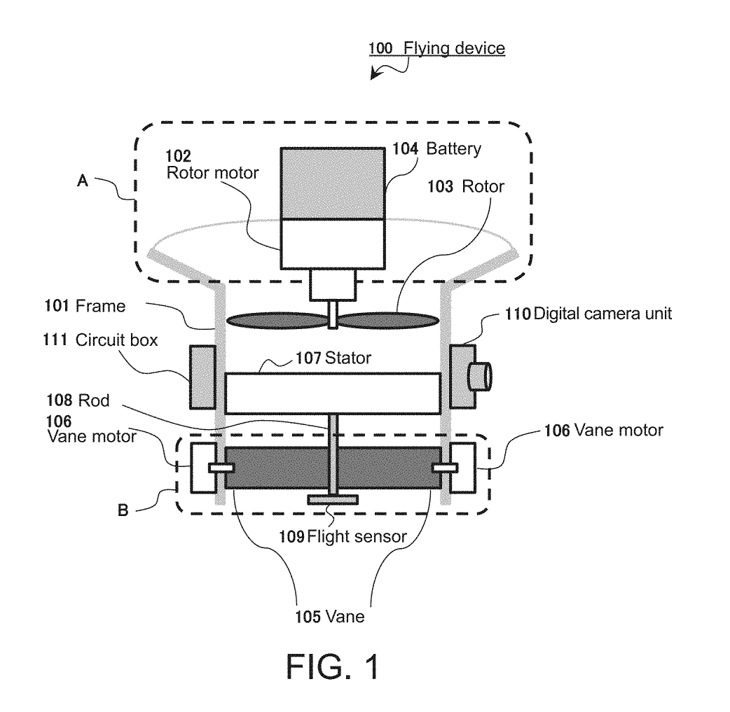

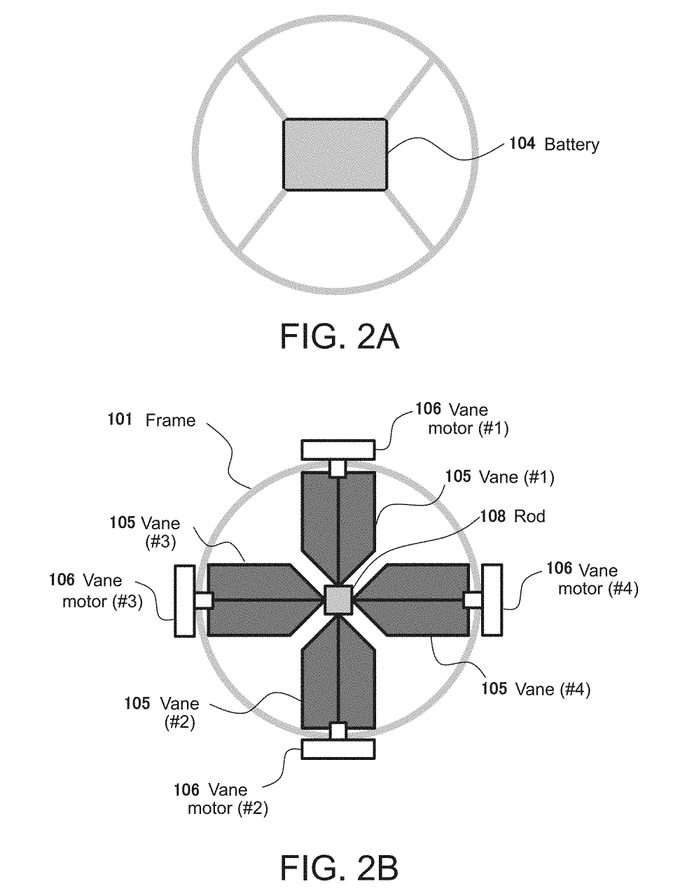

FIGS. 1 through 2B are a cross-sectional view and top views, respectively, illustrating an example configuration of a flying device 100 according to the present embodiment. FIG. 2A is a top view of the portion within dashed box A in FIG. 1 as viewed looking downwards from above the flying device 100, and FIG. 2B is a top view of the portion within dashed box B in FIG. 1 as viewed looking downwards from above the flying device 100. The dashed boxes A and B are lines added for purposes of explanation. This flying device 100 is the present embodiment implemented in the form of a drone equipped with a digital camera unit that makes it possible to take photographs from in the air.

A cylindrical frame 101 which is a body member has openings respectively on the upper side (sky side) and the lower side (ground side). As illustrated in FIGS. 1 and 2A, a battery 104, a rotor motor 102 which is driven by the battery 104, and a rotor 103 which is connected to a rotary shaft of the rotor motor 102 and is rotated by the rotor motor 102 are arranged within the upper opening. The rotor motor 102 and the rotor 103 are part of a flight propulsion unit.

As illustrated in FIG. 2B, #1 to #4 vanes 105 are arranged inside the frame 101 and are supported by a rod 108 extending down from a center portion of a stator 107 as well as by rotary shafts of #1 to #4 vane motors 106 installed at four locations on the frame 101. The vanes 105 function as inflow valves in which angles of respective blades are controlled by rotation of the rotary shafts of the respectively connected vane motors 106 in order to control the amount of incoming air that is drawn in by the rotor 103 and flows through spaces at four locations between the vanes 105. The set of the #1 to #4 vanes 105 and vane motors 106 is part of the flight propulsion unit.

As illustrated in FIG. 1, a flight sensor 109 (flight sensor unit) which is a detection unit is mounted on the lowermost portion (below the vanes 105) of the rod extending down from the center of the stator 107. The flight sensor 109 can include a gyro sensor (angular velocity sensor), an acceleration sensor, a geomagnetic sensor (direction sensor), a Global Positioning System (GPS) sensor, an atmospheric pressure sensor, an ultrasonic sensor, a laser Doppler sensor, or the like, for example, but includes at least a GPS sensor for detecting the current position of the flying device 100, an acceleration sensor for detecting the current velocity of the flying device 100, and a circuit that integrates the acceleration output by the acceleration sensor in order to calculate velocity, for example. Moreover, the flight sensor 109 also includes an atmospheric pressure sensor that detects the height of the flying device 100.

A digital camera unit 110 which is part of an information acquisition device and a circuit box 111 which is a control unit are mounted on the outer surface of the frame 101. The digital camera unit 110 captures images. The circuit box 111 stores circuit groups for controlling the rotor motor 102, the #1 to #4 vane motors 106, the flight sensor 109, the digital camera unit 110, and the battery 104 illustrated in FIGS. 1 through 2B.

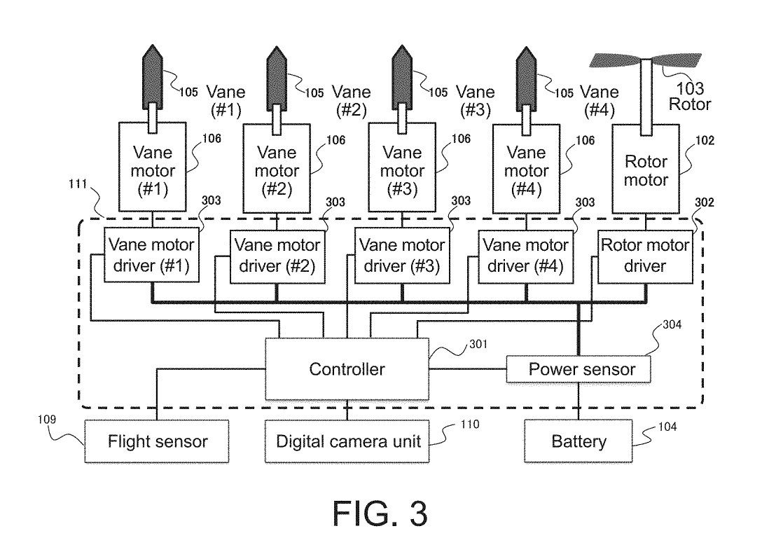

FIG. 3 is a block diagram illustrating an example of a system including the circuits in the circuit box 111 illustrated in FIG. 1 and peripheral devices that are connected to those circuits. The circuit box 111 stores a controller 301, a rotor motor driver 302, #1 to #4 vane motor drivers 303, and a power sensor 304.

The rotor motor driver 302 drives the rotor motor 102 illustrated in FIG. 1 in accordance with instructions from the controller 301. The #1 to #4 vane motor drivers 303 respectively drive the #1 to #4 vane motors 106 illustrated in FIGS. 1 and 2B in accordance with instructions from the controller 301.

The power sensor 304 supplies power to the rotor motor driver 302 and the #1 to #4 vane motor drivers 303 while monitoring the voltage of the battery 104. Moreover, although this is not explicitly illustrated in the figure, some of the power from the battery 104 is also supplied to the controller 301 as well as to the flight sensor 109 and the digital camera unit 110 illustrated in FIG. 1.

The controller 301 obtains information related to the position, velocity, and the like of the airframe of the flying device 100 from the flight sensor 109 in real time. Moreover, the controller 301 respectively sends power instruction signals with pulse-width modulated duty cycles to the rotor motor driver 302 and the #1 to #4 vane motor drivers 303 while monitoring the voltage of the battery 104 via the power sensor 304. In this way, the rotor motor driver 302 controls the rotation speed of the rotor motor 102, and the #1 to #4 vane motor drivers 303 respectively control the rotation angles of the #1 to #4 vane motors 106. Moreover, the controller 301 controls the image-capturing operation of the digital camera unit 110 (FIG. 1).

Next, the basic principle of control utilized by the controller 301 to control the rotor motor driver 302 and the #1 to #4 vane motor drivers 303 in the present embodiment will be described. The present embodiment uses a form of PID control expressed by equation (1) below.

$$\begin{matrix}〈 Equation ( 1 ) 〉 & \\ u ( t ) = {K}_{p} e ( t ) + {K}_{i} {\int }_{0}^{t} e ( τ ) d τ + {K}_{d} \frac{de ( t )}{dt} & ( 1 )\end{matrix}$$

In equation (1) above, e(t) is the error obtained at time t by subtracting a current process variable obtained by the flight sensor 109 from a target value calculated by a control process of the controller 301 (described later). Moreover, u(t) is a manipulated variable that should be input to the rotor motor driver 302 or the #1 to #4 vane motor drivers 303 at time t.

The form of PID control given by equation (1) above is a method of feedback control that combines proportional action, integral action, and derivative action related to the error described above. In other words, the first term on the right side of equation (1) implements proportional control (P control), in which the manipulated variable u(t) is controlled where the manipulated variable is regarded as a linear function of the error e(t) between the process variable and the target value. The coefficient Kₚ that is multiplied with this first term is known as the proportional gain (P gain). This proportional control causes the manipulated variable u(t) to be gradually adjusted by an amount proportional to the error e(t) between the target value and the current process variable, thereby making it possible to precisely bring the process variable u(t) closer to the target value.

Moreover, the second term on the right side of equation (1) implements integral control (I control), in which the manipulated variable u(t) is controlled proportionally to the time integral of the error e(t). The coefficient Kᵢ that is multiplied with this second term is known as the integral gain (I gain). With P control alone, as the current process variable approaches the target value, the manipulated variable u(t) becomes too small, which creates a state in which it is impossible to achieve any finer level of control and the current process variable reaches a stable state that is extremely close to the target value. This small amount of error is known as “residual error”. Therefore, PI control, which adds the I control described above to the P control, makes it possible to achieve an action in which once the residual error reaches a certain magnitude after accumulating over time, the manipulated variable u(t) is increased in order to eliminate that residual error.

Furthermore, the third term on the right side of equation (1) implements derivative control (D control), in which the manipulated variable u(t) is controlled proportionally to the derivative of the error e(t). The coefficient K_{d} that is multiplied with this third term is known as the derivative gain (D gain). The PI control described above achieves a control scheme in which the current process variable is brought closer to the target value. However, this type of control requires a prescribed period of time (time constant), and if this time constant is large, responsiveness when a disturbance occurs becomes worse, and states in which it is impossible to quickly return to the original target value can occur. Therefore, in PID control, which adds the D control described above to PI control, when the difference in the error e(t) relative to previous error (that is, the derivative) is large, the manipulated variable is increased, thereby making it possible to achieve feedback control that responds quickly to sudden disturbances.

Thus, PID control, in which the manipulated variable u(t) is controlled as the sum of three terms including the proportional term, the integral term, and the derivative term which are related to the error e(t), makes it possible to smoothly bring the respective process variables to the target values in the rotor motor driver 302 and the #1 to #4 vane motor drivers 303 and thereby makes it possible to achieve control with high precision and good responsiveness.

The controller 301 implements the PID control described above using programed control, for example. In this case, at each discrete moment that occurs at a prescribed time interval, the controller 301 uses error calculated from a discrete value of the process variable as obtained from the flight sensor 109 to calculate the manipulated variable for the current discrete moment in accordance with equations (2) and (3) below. Then, the controller 301 inputs the manipulated variables calculated using this PID control-based feedback control process to the rotor motor driver 302 and the #1 to #4 vane motor drivers 303 in order to drive the rotor motor 102 and the #1 to #4 vane motors 106.

<Equation (2)>

u(n)=u(n−1)+Δu(n) (2)

<Equation (3)>

Δu(n)=Kₚ}e(n)−e(n−1)}+Kᵢe(n)+K_{d}[{e(n)−e(n−1)}−{e(n−1)−e(n−2)}] (3)

In equation (2) above, u(n) is the manipulated variable to be calculated at the current discrete moment n, u(n−1) is the manipulated variable that was calculated at the previous discrete moment n−1, and Au(n) is a manipulated variable difference to be calculated at the current discrete moment n. Moreover, in equation (3), which gives the operation for calculating this manipulated variable difference Δu(n), e(n) is the error at the current discrete moment n as obtained by subtracting the process variable at the current discrete moment n from the target value, e(n−1) is the error at the previous discrete moment n−1 as obtained by subtracting the process variable at that previous discrete moment n−1 from the target value, and e(n−2) is the error at a further previous discrete moment n−2 as obtained by subtracting the process variable at that further previous discrete moment n−2 from the target value.

In equation (3), the proportional control operation given by the first term on the right side can be calculated by the simple operation of subtracting the error e(n−1) calculated at the previous discrete moment n−1 from the error e(n) at the current discrete moment n as obtained by subtracting the process variable at the current discrete moment n from the target value, and then multiplying the result by the P gain Kₚ. Moreover, the integral control operation given by the second term on the right side can be calculated by the simple operation of multiplying the error e(n) at the current discrete moment n by the I gain Kᵢ. Furthermore, the derivative control operation given by the third term on the right side can be calculated by the simple operation of subtracting the result of subtracting the error e(n−2) calculated at the further previous discrete moment n−2 from the error e(n−1) calculated at the previous discrete moment n−1 from the result of subtracting the error e(n−1) calculated at the previous discrete moment n−1 from the error e(n) calculated at the current discrete moment n, and then multiplying the obtained result by the D gain K_{d}. In this way, the controller 301 can rapidly execute the discrete moment operations for PID control by using the error e(n) obtained by subtracting the process variable as obtained from the flight sensor 109 at the current discrete moment n from the target value; the errors e(n−1) and e(n−2) respectively calculated at the previous and the further previous discrete moments n−1 and n−2; and the P gain Kₚ, the I gain Kᵢ, and the D gain K_{d}, which are calculated in advance.

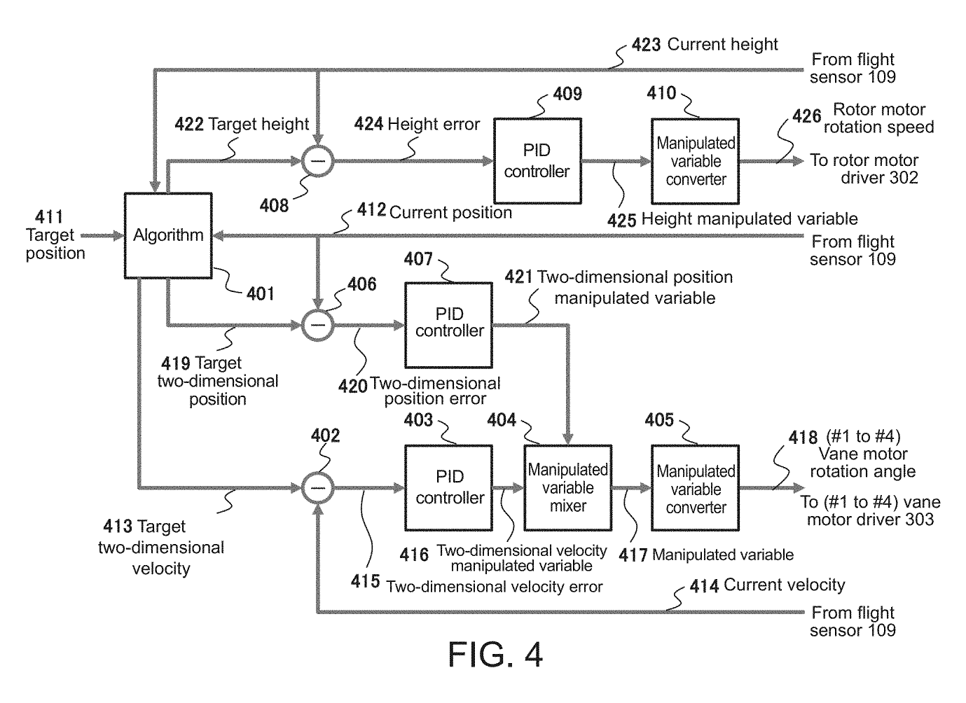

FIG. 4 is a block diagram illustrating a PID control mechanism according to the present embodiment that uses the PID control described above when the controller 301 controls the rotor motor driver 302 and the #1 to #4 vane motor drivers 303.

In an algorithm 401, which is the operation of the controller 301 executing a control process (described later), when a request to change the position of the flying device 100 is issued, first, a target position 411 is determined in the algorithm 401. The target position 411 is, for example, the position which the flying device 100 should attain after a user throws the flying device 100 up into the air, for example. The target position 411 is constituted by latitude data, longitude data, and altitude data. Meanwhile, after the user throws the flying device 100 up into the air, for example, a current position 412 that indicates the current position is sequentially input to the algorithm 401 from the GPS sensor and the atmospheric pressure sensor, for example, in the flight sensor 109. The current position 412 is constituted by latitude data and longitude data obtained from the GPS sensor as well as altitude data obtained from the atmospheric pressure sensor.

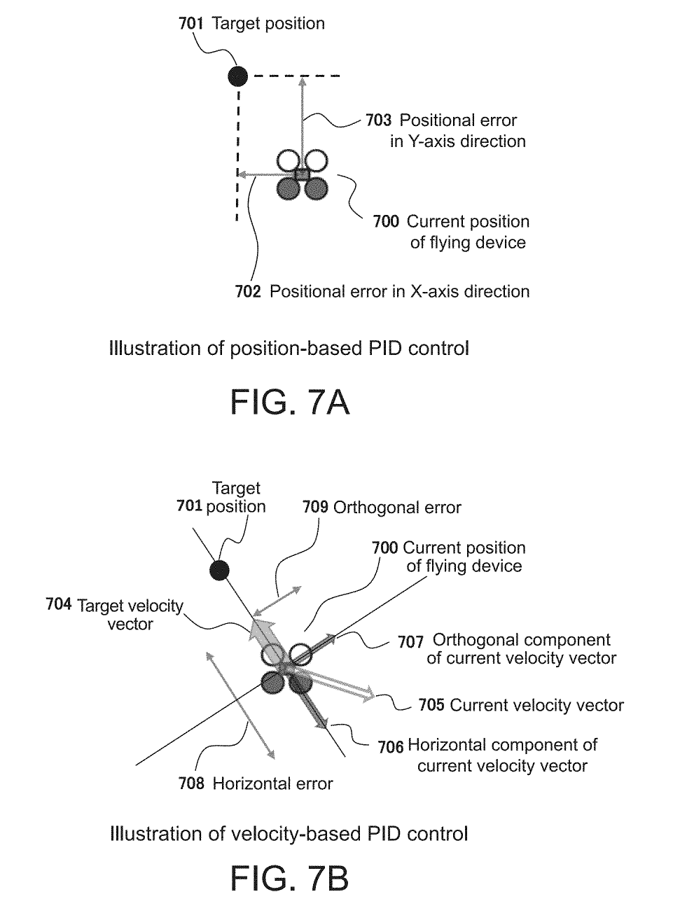

Upon determining to perform velocity PID control, the algorithm 401 converts the latitude data and longitude data for the target position 411 into a target two-dimensional velocity 413 and outputs this target two-dimensional velocity 413, which is vector data constituted by a component in the direction of an axis (hereinafter, a “horizontal axis”) going from the current position as obtained from the GPS sensor in the flight sensor 109, for example, towards the target position 411 within a plane level to the ground, as well as a component in the direction of an axis (hereinafter, an “orthogonal axis”) that is orthogonal to the horizontal axis (see the prior description of FIG. 7B).

In regards to subtractors 402 and 406, PID controllers 403 and 407, and a manipulated variable mixer 404, which will be described below, there are actually two channels corresponding to the two components of the target two-dimensional velocity 413 and to the two components of a target two-dimensional position 419 (described later). However, in FIG. 4 and the following description, only one of the channels is explicitly addressed in order to simplify the description.

One of the components of the target two-dimensional velocity 413 output by the algorithm 401 is input to the subtractor 402. Moreover, a component corresponding to either a component of a current velocity 414 in the horizontal axis direction or a component in the orthogonal axis direction (respectively corresponding to 706 and 707 in previously described FIG. 7B) is also input to the subtractor 402. This current velocity 414 is data obtained by converting the latitude data and longitude data detected by the GPS sensor in the flight sensor 109 into components in the horizontal axis direction and the orthogonal axis direction. The subtractor 402 is a function implemented in the form of the controller 301 executing a subtraction process within the control program. At each abovementioned discrete moment n, the subtractor 402 subtracts the component of the current velocity 414 from the component of the target two-dimensional velocity 413 in order to calculate a component of a two-dimensional velocity error 415 corresponding to the horizontal axis or the orthogonal axis.

This component of the two-dimensional velocity error 415 calculated at each discrete moment n is input to the PID controller 403 as the error e(n) at the discrete moment n in previously described equation (3). The PID controller 403 is a function implemented in the form of the controller 301 executing the PID control operations of previously described equations (3) and (2) within the control program. Using, as described above, the error e(n) which is the horizontal axis or orthogonal axis component of the two-dimensional velocity error 415 calculated by the subtractor 402 at the discrete moment n; the errors e(n−1) and e(n−2) which are the horizontal axis or orthogonal axis components of the two-dimensional velocity error 415 respectively calculated at the previous and further previous discrete moments n−1 and n−2; the P gain Kₚ, the I gain Kᵢ, and the D gain K_{d} that are calculated in advance; and a manipulated variable u(n−1) which is the horizontal axis or orthogonal axis component of a two-dimensional velocity manipulated variable 416 calculated at the previous discrete moment n−1, the PID controller 403 executes the operations given by previously described equations (3) and (2) in order to calculate the horizontal axis or orthogonal axis component of the two-dimensional velocity manipulated variable 416 as the manipulated variable u(n) at the current discrete moment n. The PID controller 403 calculates the horizontal axis component or orthogonal axis component of the two-dimensional velocity manipulated variable 416 for each channel and outputs it to the manipulated variable mixers 404.

Upon determining to perform position PID control in parallel with the velocity PID control described above, the algorithm 401 converts the latitude data and longitude data for the target position 411 into a target two-dimensional position 419, which is vector data constituted by a component in the horizontal axis direction and a component in the orthogonal axis direction, and the algorithm 401 outputs this target two-dimensional position 419. This process of executing position PID control in parallel with velocity PID control is known as a hybrid PID control process.

One of the components of the target two-dimensional position 419 output by the algorithm 401 is input to the subtractor 406. Moreover, a component corresponding to either a component of the current position 412 in the horizontal axis direction or a component in the orthogonal axis direction is also input to the subtractor 406. This current position 412 is data obtained by converting the latitude data and longitude data detected by the GPS sensor in the flight sensor 109 into components in the horizontal axis direction and the orthogonal axis direction. Similar to the subtractor 402, the subtractor 406 is a function implemented in the form of the controller 301 executing a subtraction process within the control program. At each abovementioned discrete moment n, the subtractor 406 subtracts the component of the current position 412 from the component of the target two-dimensional position 419 in order to calculate a component of a two-dimensional position error 420 corresponding to the horizontal axis or the orthogonal axis.

This component of the two-dimensional position error 420 calculated at each discrete moment n is input to the PID controller 407 as the error e(n) at the discrete moment n in previously described equation (3). Similar to the PID controller 403, the PID controller 407 is a function implemented in the form of the controller 301 executing the PID control operations of previously described equations (3) and (2) within the control program. Using, as described above, the error e(n) which is the horizontal axis or orthogonal axis component of the two-dimensional position error 420 calculated by the subtractor 402 at the discrete moment n; the errors e(n−1) and e(n−2) which are the horizontal axis or orthogonal axis components of the two-dimensional position error 420 respectively calculated at the previous and further previous discrete moments n−1 and n−2; the P gain Kₚ, the I gain Kᵢ, and the D gain K_{d} that are calculated in advance; and a manipulated variable u(n−1) which is the horizontal axis or orthogonal axis component of a two-dimensional position manipulated variable 421 calculated at the previous discrete moment n−1, the PID controller 407 executes the operations given by previously described equations (3) and (2) in order to calculate the horizontal axis or orthogonal axis component of the two-dimensional position manipulated variable 421 which is the manipulated variable u(n) at the current discrete moment n. The PID controller 408 calculates the horizontal axis component or orthogonal axis component of the two-dimensional position manipulated variable 421 for each channel and outputs it to the manipulated variable mixers 404.

When the algorithm 401 determines to perform only velocity PID control, the manipulated variable mixer 404 for each channel corresponding to the horizontal axis or the orthogonal axis outputs the horizontal axis or orthogonal axis component of the two-dimensional velocity manipulated variable 416 output from the PID controllers 403 to a manipulated variable converter 405 as-is as the horizontal axis or orthogonal axis component of a final manipulated variable 417. Meanwhile, when the algorithm 401 determines to perform position PID control in addition to velocity PID control, the manipulated variable mixer 404 for each channel corresponding to the horizontal axis or the orthogonal axis respectively multiplies the corresponding horizontal axis or orthogonal axis component of the two-dimensional velocity manipulated variable 416 output from the PID controllers 403 and the horizontal axis or orthogonal axis component of the two-dimensional position manipulated variable 421 output from the PID controllers 407 by respective weighting values determined in a control process executed by the controller 301 (described later). Then, the manipulated variable mixer 404 adds together these multiplication results, and then outputs the addition result to the manipulated variable converter 405 as the horizontal axis or orthogonal axis component of the final manipulated variable 417.

On the basis of the horizontal axis and orthogonal axis components of the final manipulated variables 417 respectively input from the manipulated variable mixers 404 for the respective channels corresponding to the horizontal axis and the orthogonal axis, the manipulated variable converter 405 generates #1 to #4 vane motor rotation angles 418 for driving the #1 to #4 vane motors 106 (see FIGS. 1 and 2B), and then outputs these #1 to #4 vane motor rotation angles 418 to the respective #1 to #4 vane motor drivers 303 (see FIG. 3).

Meanwhile, a target height 422 output from the algorithm 401 is input to a subtractor 408. A current height 423 is also input to the subtractor 408. This current height 423 is output data from the atmospheric pressure sensor of the flight sensor 109, for example. Similar to the subtractors 402 and the like, the subtractor 408 is a function implemented in the form of the controller 301 executing a subtraction process within the control program. At each abovementioned discrete moment n, the subtractor 408 subtracts the current height 423 from the target height 422 in order to calculate a height error 424. This height error 424 calculated at each discrete moment n is input to a PID controller 409 as the error e(n) at the discrete moment n in previously described equation (3). Similar to the PID controllers 403 and the like, the PID controller 409 is a function implemented in the form of the controller 301 executing the PID control operations of previously described equations (3) and (2) within the control program. Using, as described above, the error e(n) which is the height error 424 calculated by the subtractor 408 at the discrete moment n; the errors e(n−1) and e(n−2) which are the height errors 424 respectively calculated at the previous and further previous discrete moments n−1 and n−2; the P gain Kₚ, the I gain Kᵢ, and the D gain K_{d} that are calculated in advance; and a manipulated variable u(n−1) which is a height manipulated variable 425 calculated at the previous discrete moment n−1, the PID controller 409 executes the operations given by previously described equations (3) and (2) in order to calculate the height manipulated variable 425 which is the manipulated variable u(n) at the current discrete moment n.

A manipulated variable converter 410, on the basis of the height manipulated variable 425 input from the PID controller 409, generates a rotor motor rotation speed 426 for driving the rotor motor 102 (see FIG. 1), and then outputs this rotor motor rotation speed 426 to the rotor motor driver 302 (see FIG. 3).

If further changes to the target position 411 become necessary in the algorithm 401, the same PID control-based feedback control process described above is performed repeatedly.

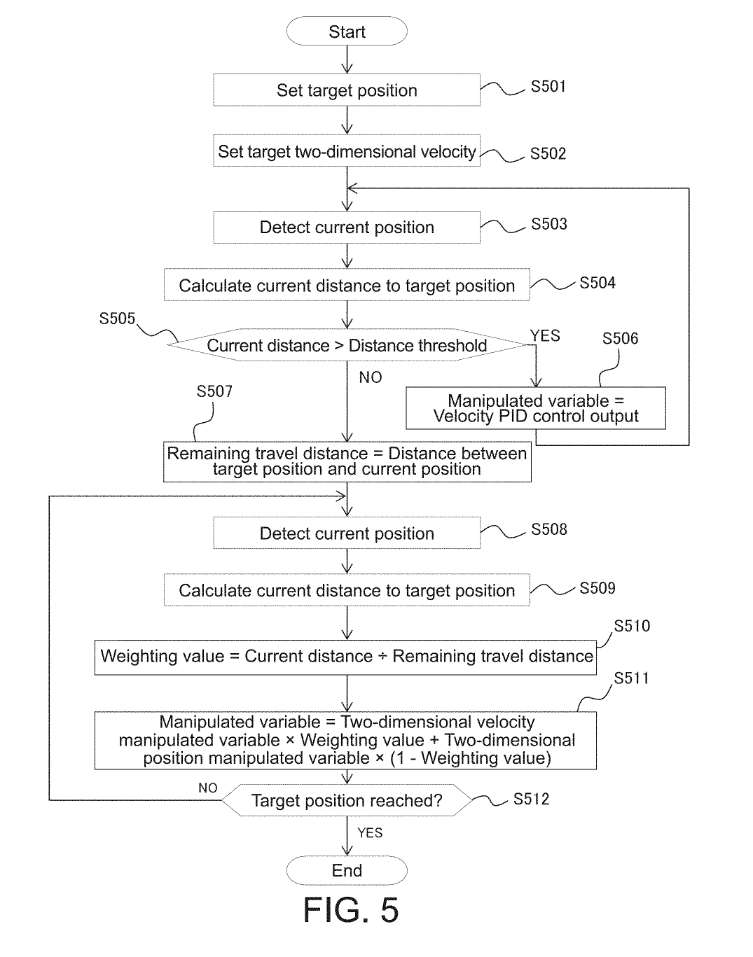

FIG. 5 is a flowchart illustrating an example of a motion control process for the controller 301 illustrated in FIG. 3. This process can be implemented as a process in which a CPU built into the controller 301 executes a control program stored in a memory (not illustrated in the figures) that is similarly built in.

After a user performs a process of throwing the flying device 100 up into the air, for example (not illustrated), the controller 301 sets the target position 411 illustrated in FIG. 4 on the basis of another control process (not illustrated) (step S501). The target position 411 is, for example, the position which the flying device 100 should attain after the user throws the flying device 100 up into the air, for example. The target position 411 is constituted by latitude data, longitude data, and altitude data.

Next, as described above in the description of FIG. 4, the controller 301 converts the latitude data and longitude data for the target position 411 set in step S501 into a target two-dimensional velocity 413, which is vector data constituted by a component in the horizontal axis direction and a component in the orthogonal axis direction, and sets this target two-dimensional velocity 413 (step S502).

Then, the controller 301 repeatedly executes the following sequence of processes from step S503 to S506. First, the controller 301 detects the current position 412 from the GPS sensor and the atmospheric pressure sensor, for example, in the flight sensor 109 (step S503). The current position 412 is constituted by latitude data and longitude data obtained from the GPS sensor as well as altitude data obtained from the atmospheric pressure sensor.

Next, the controller 301 calculates the linear distance from the current position 412 detected in step S503 to the target position 411 set in step S501 as a current distance (step S504).

The controller 301 then determines whether the current distance calculated in step S504 is greater than a prescribed distance threshold (step S505).

If the determination in step S505 yields YES, the controller 301 executes, with respect to the target two-dimensional velocity 413, only the velocity PID control process described with reference to the subtractors 402 and the PID controllers 403 in FIG. 4. In this case, the position PID control process described with reference to the subtractors 406 and the PID controllers 407 in FIG. 4 is not executed. As a result, the controller 301 outputs the components of the two-dimensional velocity manipulated variable 416 output from the PID controllers 403 to the manipulated variable converter 405 as-is as the components of the final manipulated variable 417. Furthermore, the controller 301 uses the manipulated variable converter 405 to generate the #1 to #4 vane motor rotation angles 418 and outputs these #1 to #4 vane motor rotation angles 418 to the respective #1 to #4 vane motor drivers 303 (see FIG. 3) (step S506). Then, the controller 301 returns to the process of step S503 and repeatedly executes the processes of steps S503 to S506.

When, as a result of the repeating process described above, the flying device 100 gets close to the target position 411 and the current distance becomes less than or equal to the prescribed distance threshold (the determination in step S505 yields NO), the controller 301 executes the hybrid PID control process described below, which is a process in which velocity PID control and position PID control are performed in parallel. In the hybrid PID control process, first, the controller 301 sets the distance between the target position 411 and the current position 412 (the current distance) as a remaining travel distance (step S507).

Next, the controller 301 executes the sequence of control processes from step S508 to S512 until it is determined in step S512 that the flying device 100 has reached the target position 411. First, the controller 301 detects the current position 412 similarly to in step S503 (step S508) and executes the same process of calculating the current distance as in step S504 (step S509).

Then, the controller 301 calculates the result of dividing the current distance calculated in step S509 by the remaining travel distance calculated in step S507 (that is, the ratio of the current distance to the remaining travel distance) as a weighting value (step S510).

Next, the controller 301 executes, with respect to the target two-dimensional velocity 413, the velocity PID control process described with reference to the subtractors 402 and the PID controllers 403 in FIG. 4. In parallel, the controller 301 executes, with respect to the target two-dimensional position 419, the position PID control process described with reference to the subtractors 406 and the PID controllers 407 in FIG. 4. Furthermore, in the process of the manipulated variable mixer 404 for each channel, the controller 301 respectively outputs the result of multiplying the component of the two-dimensional velocity manipulated variable 416 output from the PID controller 403 by the weighting value calculated in step S510 as well as the result of multiplying the component of the two-dimensional position manipulated variable 421 output from the PID controller 407 by the quantity (1-weighting value), as shown in the operation given by equation (4) below, and adds them together. The resulting sum is then outputted to the manipulated variable converter 405 as the corresponding component of the manipulated variable 417.

<Equation (4)>

Component of Manipulated Variable 417=Component of Two-Dimensional Velocity Manipulated Variable 416×Weighting Value+Component of Two-Dimensional Position Manipulated Variable 421×(1-Weighting Value) (4)

As the process of the manipulated variable converter 405, the controller 301, on the basis of the components of the manipulated variable 417 respectively input as a result of the processes performed according to the above equation (4) by the manipulated variable mixers 404 for each channel, generates #1 to #4 vane motor rotation angles 418 for driving the #1 to #4 vane motors 106 (see FIGS. 1 and 2B), and then outputs these #1 to #4 vane motor rotation angles 418 to the respective #1 to #4 vane motor drivers 303 (see FIG. 3) (step S511).

Then, by determining whether the current distance calculated in step S509 has become substantially equal to zero, the controller 301 determines whether the flying device 100 has reached the target position 411 set in step S501 (step S512).

If the determination in step S512 yields NO, the controller 301 returns to the process of step S508 and repeatedly executes the processes of steps S508 to S512.

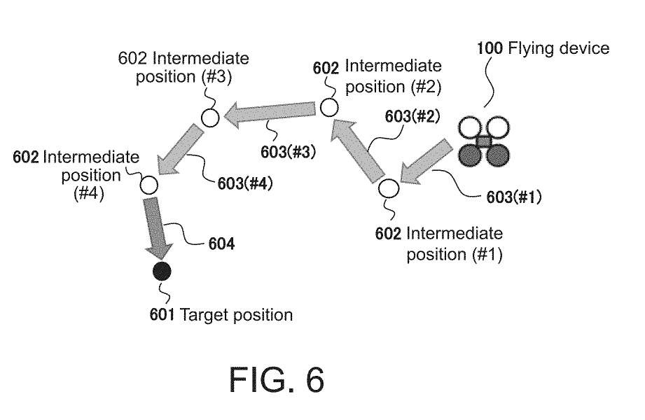

FIG. 6 is a drawing for explaining the operation of the present embodiment as implemented in the control process of the controller 301 in accordance with FIGS. 1 to 5 as described above. Consider, for example, a case in which after the user throws the flying device 100 up into the air, the flying device 100 performs the motion of flying to trace out a given trajectory by means of autonomous flight and then returning to the user's hand. In this case, in which the flying device 100 passes through a plurality of intermediate positions 602 labeled #1 to #4 in the trajectory illustrated in FIG. 6 and then reaches a target position 601 which is the destination, the present embodiment makes it possible to both, during #1 to #4 motion controls 603, maintain a substantially constant speed by performing velocity PID control alone, as well as to, in a motion control 604 from the #4 intermediate position 602 to the target position 601, achieve a smooth stop at the target position 601 by performing control of gradually transitioning from velocity PID control to position PID control.

Although in the embodiment described above the hybrid PID control process is executed when the current distance becomes small in comparison to the prescribed distance threshold, the hybrid PID control process may be executed immediately after flight begins, or the hybrid PID control process may be executed in response to various other conditions.

Moreover, although in the embodiment described above the strengths of the velocity PID control and the position PID control change gradually, these strengths may be switched between two levels or between a plurality of levels.

Although the embodiment above describes an example in which the flying device is equipped with a digital camera unit, the flying device may be equipped with various other types of sensor devices such as a measurement device including a sensor that collects a temperature distribution or an atmospheric composition distribution, for example, or these types of devices may be omitted.

Although the embodiment described above is a so-called ducted-fan device that includes the single rotor motor 102 and the four #1 to #4 vane motors 106, the flying device may also be a multicopter device that includes a plurality (such as four or six) of the rotor motors 102. Alternatively, the flight propulsion unit may be implemented in the form of a mechanism that is propelled by air pressure or engine output.

It will be apparent to those skilled in the art that various modifications and variations can be made in the present invention without departing from the spirit or scope of the invention.

Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A flying device, comprising:
a propulsion unit;
a sensor unit that detects at least a current position and a current velocity of the flying device; and
a processor configured to receive a target position and calculate or receive a target velocity corresponding to the target position, the processor being further configured to perform:
a velocity feedback control in which the current velocity is taken as a process variable and the target velocity is taken as a setpoint so as to generate a velocity-feedback manipulated variable for controlling the propulsion unit, and
a position feedback control in which the current position is taken as a process variable and the target position is taken as a setpoint so as to generate a position-feedback manipulated variable for controlling the propulsion unit,
wherein in at least a prescribed distance range of the flying device with respect to the target position, the processor calculates a weighted average of the velocity-feedback manipulated variable and the position-feedback manipulated variable and controls the proposition unit in accordance with the weighted averaged manipulated variable, thereby performing velocity-position hybrid feedback control, and
wherein in said at least the prescribed distance range, the larger a current distance of the current position of the flying device from the target position is, the more weight the processor assigns to the velocity-feedback manipulated variable in the weighted average, and the smaller the current distance becomes, the more weight the processor assigns to the position-feedback manipulated variable in the weighted average, so that as the flying device approaches the target position, the position feedback control becomes more dominant relative to the velocity feedback control.

2. The flying device according to claim 1, wherein the prescribed distance range is within a prescribed distance from the target position inclusive of the target position, and when the current position of the flying vehicle is beyond said distance range, the processor performs only the velocity feedback control without performing the position feedback control in controlling the propulsion unit.

3. The flying device according to claim 1, wherein in the prescribed distance range, the weight the processor assigns to the velocity-feedback manipulated variable and the weight the processor assigns to the position-feedback manipulated variable in the weighted average are both linear functions of the current distance of the current position of the flying device from the target position as detected by the detection unit.

4. The flying device according to claim 3, wherein in the prescribed distance range, the weight the processor assigns to the velocity-feedback manipulated variable is a ratio of the current distance of the current position of the flying device from the target position as detected by the detection unit relative to an initial distance, the initial distance being either said prescribed distance or a distance of the flying device from the target position when the processor initially determines that the flying device is within the prescribed distance range and starts performing said velocity-position hybrid feedback control, a remaining weight being assigned to the position-feedback manipulated variable in the weighted average.

5. The flying device according to claim 1, wherein each of the velocity feedback control and the position feedback control is proportional-integral-derivative (PID) feedback control.

6. A method to be performed by a processor in a flying device for controlling the flying device, the flying device further including a propulsion unit and a sensor unit that detects at least a current position and a current velocity of the flying device, the processor in the flying device being configured to:
receive a target position and calculate or receive a target velocity corresponding to the target position:
perform a velocity feedback control in which the current velocity is taken as a process variable and the target velocity is taken as a setpoint so as to generate a velocity-feedback manipulated variable for controlling the propulsion unit, and
perform a position feedback control in which the current position is taken as a process variable and the target position is taken as a setpoint so as to generate a position-feedback manipulated variable for controlling the propulsion unit,
the method comprising:
in at least a prescribed distance range of the flying device with respect to the target position, causing the processor to calculate a weighted average of the velocity-feedback manipulated variable and the position-feedback manipulated variable; and
controlling the proposition unit in accordance with the weighted averaged manipulated variable, thereby performing velocity-position hybrid feedback control, and
wherein in said at least the prescribed distance range, the larger a current distance of the current position of the flying device from the target position is, the more weight the processor assigns to the velocity-feedback manipulated variable in the weighted average, and the smaller the current distance becomes, the more weight the processor assigns to the position-feedback manipulated variable in the weighted average, so that as the flying device approaches the target position, the position feedback control becomes more dominant relative to the velocity feedback control.

7. The method according to claim 6, wherein the prescribed distance range is within a prescribed distance from the target position inclusive of the target position, and when the current position of the flying vehicle is beyond said distance range, the processor performs only the velocity feedback control without performing the position feedback control in controlling the propulsion unit.

8. The method according to claim 6, wherein in the prescribed distance range, the weight the processor assigns to the velocity-feedback manipulated variable and the weight the processor assigns to the position-feedback manipulated variable in the weighted average are both linear functions of the current distance of the current position of the flying device from the target position as detected by the detection unit.

9. The method according to claim 8, wherein in the prescribed distance range, the weight the processor assigns to the velocity-feedback manipulated variable is a ratio of the current distance of the current position of the flying device from the target position as detected by the detection unit relative to an initial distance, the initial distance being either said prescribed distance or a distance of the flying device from the target position when the processor initially determines that the flying device is within the prescribed distance range and starts performing said velocity-position hybrid feedback control, a remaining weight being assigned to the position-feedback manipulated variable in the weighted average.

10. The method according to claim 6, wherein each of the velocity feedback control and the position feedback control is proportional-integral-derivative (PID) feedback control.

11. A non-transitory computer-readable storage medium having stored thereon a program executable by a processor in a flying device that further includes a propulsion unit and sensor unit that detects at least a current position and a current velocity of the flying device, the program configuring the processor to:
receive a target position and calculate or receive a target velocity corresponding to the target position,
perform a velocity feedback control in which the current velocity is taken as a process variable and the target velocity is taken as a setpoint so as to generate a velocity-feedback manipulated variable for controlling the propulsion unit, and
perform a position feedback control in which the current position is taken as a process variable and the target position is taken as a setpoint so as to generate a position-feedback manipulated variable for controlling the propulsion unit,
wherein in at least a prescribed distance range of the flying device with respect to the target position, the program causes the processor to calculate a weighted average of the velocity-feedback manipulated variable and the position-feedback manipulated variable and control the proposition unit in accordance with the weighted averaged manipulated variable, thereby performing velocity-position hybrid feedback control, and
wherein in said at least the prescribed distance range, the larger a current distance of the current position of the flying device from the target position is, the more weight the processor assigns to the velocity-feedback manipulated variable in the weighted average, and the smaller the current distance becomes, the more weight the processor assigns to the position-feedback manipulated variable in the weighted average, so that as the flying device approaches the target position, the position feedback control becomes more dominant relative to the velocity feedback control.

12. The non-transitory computer-readable storage medium according to claim 11, wherein the program configures the processor such that the prescribed distance range is within a prescribed distance from the target position inclusive of the target position, and when the current position of the flying vehicle is beyond said distance range, the processor performs only the velocity feedback control without performing the position feedback control in controlling the propulsion unit.

13. The non-transitory computer-readable storage medium according to claim 11, wherein the program configures the processor such that in the prescribed distance range, the weight the processor assigns to the velocity-feedback manipulated variable and the weight the processor assigns to the position-feedback manipulated variable in the weighted average are both linear functions of the current distance of the current position of the flying device from the target position as detected by the detection unit.

14. The non-transitory computer-readable storage medium according to claim 13, wherein the program configures the processor such that in the prescribed distance range, the weight the processor assigns to the velocity-feedback manipulated variable is a ratio of the current distance of the current position of the flying device from the target position as detected by the detection unit relative to an initial distance, the initial distance being either said prescribed distance or a distance of the flying device from the target position when the processor initially determines that the flying device is within the prescribed distance range and starts performing said velocity-position hybrid feedback control, a remaining weight being assigned to the position-feedback manipulated variable in the weighted average.

15. The non-transitory computer-readable storage medium according to claim 13, wherein the program configures the processor such that each of the velocity feedback control and the position feedback control is proportional-integral-derivative (PID) feedback control.
